(19) United States
(12) Patent Application Publication
(10) Pub. No.: US 2026/0252530 A1
(43) Pub. Date: Aug. 27, 2026

(54) Scalable and Cost-Efficient Information Retrieval Architecture for Massive Datasets

(71) Applicant: Google LLC, Mountain View, CA (US)

(72) Inventors: Filip Pavetic, Zurich (CH); Alexander-Teodor Voicu, Zurich (CH); Martin Ulrich Seiler, Mutschellen (CH); Philip Wenjie Sun, New York, NY (US); Ruiqi Guo, Elmhurst, NY (US); Hanna Maria Pasula, Zurich (CH); David Simcha, Jersey City, NJ (US); Felix Chern, New York, NY (US)

(21) Appl. No.: 19/644,598

(22) Filed: Apr. 10, 2026

Related U.S. Application Data
(63) Continuation of application No. 17/886,860, filed on Aug. 12, 2022, now abandoned.

(51) Int. Cl. G06F 16/13; G06F 3/06

(52) U.S. Cl. CPC G06F 16/13; G06F 3/0611; G06F 3/0649; G06F 3/0685

(57) ABSTRACT

Provided is a scalable and cost-efficient storage architecture for large-scale datasets, such as Internet-scale datasets that include very large numbers (e.g., billions) of data elements. More particularly, provided is a bifurcated storage architecture that includes a first data index stored by a first set of storage media and a second data index stored by a second set of storage media, where the first set of storage media has a lower latency than the second set of storage media.

### PRIORITY CLAIM

The present application is a continuation of U.S. application Ser. No. 17/886,860 having a filing date of Aug. 12, 2022. Applicant claims priority to and the benefit of each of such applications and incorporate all such applications herein by reference in its entirety.

### FIELD

The present disclosure relates generally to a scalable and cost-efficient information retrieval for large-scale datasets. More particularly, the present disclosure relates to a bifurcated information retrieval architecture that includes multiple data indices stored on multiple different sets of storage media having differing latency characteristics.

### BACKGROUND

Search engine indexing refers to the collecting, parsing, and storing of data within an index to facilitate fast and accurate information retrieval. Specifically, an index can be generated for a dataset that includes a number of data elements, such as webpages or other documents, images, videos, audio files, data files, entities, and/or other data elements in a dataset. One purpose of generating and storing an index is to optimize speed and performance in finding and returning relevant data elements that are potentially responsive to a search query.

In some settings, a dataset can include a massive number (e.g., millions or billions) of data elements. One example is Internet-scale datasets which seek to index (approximately) all data elements (e.g., webpages, videos, etc.) across the entire Internet. In another example, large, globally popular data sharing platforms (e.g., video sharing platforms) may include massive numbers of data elements (e.g., hundreds of millions of videos).

In general, there are a number of different storage mediums which offer different benefits and challenges when used to store a data index. As one example, storage media (e.g., such as Random Access Memory (RAM)) that offers low latency may enable faster retrieval of results from the index and may be more applicable to indexing and retrieval techniques that require dynamic changes or updates to the index. However, RAM and other low-latency media have significant operational cost and therefore it is typically infeasible to use these media to store the index of a massive dataset. As another example, other storage media (e.g., such as Solid State Drive (SSD) or “flash”) may have a relatively higher latency, but a more reasonable operational cost. Therefore, these media are more likely to be used to store the index of a massive dataset. However, SSD or other similar storage media may not be applicable to indexing and retrieval techniques that require dynamic changes or updates to the index.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for indexing a dataset comprising a large number of data elements. The method includes, for each of a plurality of storage periods: maintaining, by a computing system, a first data index stored by a first set of storage media having a first latency associated therewith; and maintaining, by the computing system, a second data index stored by a second set of storage media having a second latency associated therewith, the second latency being greater than the first latency, the second data index containing existing data elements included in the dataset. During pendency of the storage period, the method includes receiving, by the computing system, one or more additional data elements that have been added to the dataset; and indexing, by the computing system, one or more representations of the one or more additional data elements in the first data index stored by the first set of storage media. During pendency of the storage period or upon expiration of the storage period, the method includes transferring, by the computing system, the one or more representations of the one or more additional data elements contained in the first data index stored by the first set of storage media to the second data index stored by the second set of storage media.

Another example aspect of the present disclosure is directed to a computing system. The computing system includes a first set of storage media that stores a first data index, the first set of storage media having a first latency associated therewith. The computing system includes a second set of storage media that stores a second data index, the second set of storage media having a second latency associated therewith, the second latency being greater than the first latency, the second data index containing existing data elements included in a dataset. The computing system includes one or more processors and one or more non-transitory computer-readable media that store instructions that, when executed by the one or more processors, cause the computing system to perform operations. The operations include, during pendency of a storage period: receiving, by the computing system, one or more additional data elements that have been added to the dataset; and indexing, by the computing system, one or more representations of the one or more additional data elements in the first data index stored by the first set of storage media. The operations include, during pendency of the storage period or upon expiration of the storage period: transferring, by the computing system, the one or more representations of the one or more additional data elements contained in the first data index stored by the first set of storage media to the second data index stored by the second set of storage media.

Another example aspect of the present disclosure is directed to one or more non-transitory computer-readable media that store instructions that, when executed by one or more processors, cause the one or more processors to perform operations. The operations include, for each of a plurality of storage periods: maintaining, by a computing system, a first data index stored by a first set of storage media having a first latency associated therewith; and maintaining, by the computing system, a second data index stored by a second set of storage media having a second latency associated therewith, the second latency being greater than the first latency, the second data index containing existing data elements included in a dataset. The operations include, during pendency of the storage period: receiving, by the computing system, one or more additional data elements that have been added to the dataset; and indexing, by the computing system, one or more representations of the one or more additional data elements in the first data index stored by the first set of storage media. The operations include, during pendency of the storage period or upon expiration of the storage period: transferring, by the computing system, the one or more representations of the one or more additional data elements contained in the first data index stored by the first set of storage media to the second data index stored by the second set of storage media.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended FIGs., in which:

FIG. 1 depicts a block diagram of an example computing system according to example embodiments of the present disclosure.

FIG. 2 depicts a block diagram of an example computing device according to example embodiments of the present disclosure.

FIG. 3 depicts a graphical representation of a process for indexing data elements according to example embodiments of the present disclosure.

FIG. 4 depicts a graphical diagram of an example hierarchical retrieval technique according to example embodiments of the present disclosure.

FIG. 5 depicts a flow chart diagram of an example method to index data elements according to example embodiments of the present disclosure

Reference numerals that are repeated across plural FIG.s are intended to identify the same features in various implementations.

### DETAILED DESCRIPTION

Generally, the present disclosure is directed to a scalable and cost-efficient storage architecture for large-scale datasets, such as Internet-scale datasets that include very large numbers (e.g., billions) of data elements. More particularly, the present disclosure relates to a bifurcated storage architecture that includes a first data index stored by a first set of storage media and a second data index stored by a second set of storage media, where the first set of storage media has a lower latency than the second set of storage media.

According to an aspect of the present disclosure, the indexing of the dataset can occur over a number of storage periods. During the pendency of each storage period, any new data elements that are added to the dataset can be indexed into the first data index, while the majority (e.g., all) of the existing data elements of dataset can be indexed in the second data index. Then, upon expiration of the storage period, the new data elements included in the first data index can be transferred from the first data index stored by the first set of storage media to the second data index stored by the second set of storage media. Additionally or alternatively, all of the data elements indexed in the second data index can be updated (e.g., recomputed or otherwise re-indexed).

Thus, in some implementations, an information retrieval index can be split into two (e.g., partially overlapping) parts: fresh (e.g., new data elements introduced within the most recent storage period (e.g., the last 30 days)) and stable (e.g., all data elements existing in the dataset except those introduced within at least a portion of the most recent storage period (e.g., except elements introduced within the last 7 days).

Furthermore, the fresh index can be stored on storage media having relatively lower latency and higher applicability to dynamic updates, but higher operational cost (e.g., RAM). On the other hand, the stable index can be stored on storage media having relatively higher latency and lower applicability to dynamic updates, but lower operational cost (e.g., SSD). One benefit of such a split is that the retrieval system needs to support (complex) instant updates of only the small fresh index. The retrieval system can then update the larger stable index periodically by recomputing new versions of the entire served dataset at once.

Furthermore, according to another aspect, in some implementations, a plurality of centroids can be stored in the first set of storage media. The plurality of centroids can respectively correspond to a plurality of partitions of the existing data elements included in the second data index stored by the second set of storage media. For example, the centroids can be used to perform a hierarchical retrieval technique (e.g., such as a hierarchical nearest neighbor search).

As an example, in some implementations, the hierarchical retrieval technique first can include identifying one or more of the centroids stored by the first set of storage media based on the query. Next, the hierarchical retrieval technique can include accessing, from the second set of storage media, only the data elements included in the one or more of the partitions respectively associated with the one or more centroids identified based on the query.

Hierarchical retrieval techniques of this nature can identify results that are responsive to the query with reduced computational costs (e.g., by evaluating only a smaller subset of the indexed data elements included in the identified partition(s), rather than all indexed data elements). Further, because the centroids are maintained in the first set of storage media having the lower latency, they can be accessed and/or updated faster and with reduced computational cost.

The proposed approach provides a number of technical effects and benefits. In particular, as discussed above, there are a number of different storage mediums which offer different benefits and challenges when used to store a data index. By maintaining the large majority of data elements in a set of storage media that have relatively lower operational cost, but also introducing new elements via storage in a set of storage media that is more amenable to dynamic changes, an improved balance can be struck between latency and operational cost.

For example, while storing all representations in a second set of storage media that has relatively lower operational cost may be ideal; a problem arises in as much as these types of storage media may not natively support online updates. Therefore, by using a first set of storage media that is more amenable to dynamic updates to handle newly indexed data elements while periodically updating the full set of representations on the second set of storage media, the benefits of each style of storage media can be obtained in a more computationally efficient manner. Further, as discussed above, a hierarchical retrieval algorithm can be used to obtain the benefits of each style of storage media.

Thus, the present disclosure provides an architecture for scalable and cost-efficient matching which stores a majority of indexed data on (e.g., remote) SSD. The proposed approach allows an information retrieval system to support low query-per-second (QPS) use-cases (e.g., detection and removal of objectionable content) with low operational cost (e.g., due to total SSD operational cost required being very low even at massive scale). The proposed approaches open up the previously inaccessible option of performing a matching or search query against all elements in a massive dataset. High QPS use cases may also remain efficient through the use of hierarchical retrieval techniques that efficiently leverage multiple different types of storage media.

With reference now to the FIGS., example embodiments of the present disclosure will be discussed in further detail.

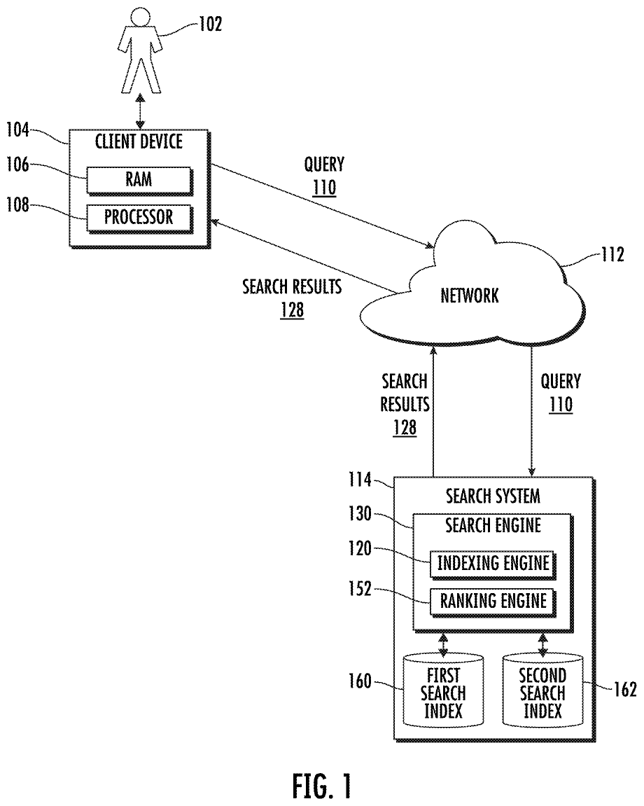

FIG. 1 shows an example search system 114. The search system 114 is an example of an information retrieval system implemented as one or more computer programs on one or more computers in one or more locations, in which the systems, components, and techniques described below can be implemented.

A user 102 can interact with the search system 114 through a client device 104. For example, the client device 104 can be a computer coupled to the search system 114 through a data communication network 112, e.g., local area network (LAN) or wide area network (WAN), e.g., the Internet, or a combination of networks.

In some cases, the search system 114 can be implemented on the client device 104, for example, if a user installs an application that performs searches on the client device 104. The client device 104 will generally include a memory, e.g., a random access memory (RAM) 106, for storing instructions and data and a processor 108 for executing stored instructions. The memory can include both read only and writable memory.

A user 102 can use the client device 104 to submit a query 110 to a search system 114. A search engine 130 within the search system 114 performs a search to identify resources matching the query. When the user 102 submits a query 110, the query 110 may be transmitted through the network 112 to the search system 114. The query can include natural language, image, video, audio, a representation of a data element, and/or other data types. In some implementations, a query can itself be transformed into a query representation (e.g., using a model similar to (e.g., trained jointly with) the model that transforms data elements into representations (e.g., embeddings), as described in further detail below.

The search system 114 responds to the query 110 by generating search results 128, which are transmitted through the network to the client device 104 for presentation to the user 102, e.g., as a search results web page to be displayed by a web browser running on the client device 104. In another example, rather than a web browser application, the client device 104 may be running a dedicated application (e.g., mobile application) that is specifically designed to interact with the search system 114.

An example search result can include a web page title, a snippet of text or a portion of an image extracted from the web page, and the Uniform Resource Locator (URL) of the web page or other relevant resource, for example. The snippet of text from a web page or other resource can contain, for example, one or more contiguous (e.g., adjacent words or sentences) or non-contiguous portions of text. Another example search result can include a title of a stored video, a thumbnail or frame extracted from the video, and the Uniform Resource Locator (URL) of the stored video. Many other examples are possible within the context of an information retrieval system. For example, data elements can correspond to videos, images, webpages, files, entities, and/or other data elements.

The search system 114 includes a first search index stored in a first set of storage media 160 and a second search index stored in a second set of storage media 162. The search system 114 also includes search engine 130. In some instances, the first search index 160 stored in the first set of storage media can be referred to as a first database while the second search index 162 stored in the second set of storage media can be referred to as a second database.

In this specification, the term “database” will be used broadly to refer to any collection of data: the data does not need to be structured in any particular way, or structured at all, and it can be stored on storage devices in one or more locations. Thus, for example, databases can include multiple collections of data, each of which may be organized and accessed differently. Similarly, in this specification the term “engine” will be used broadly to refer to a software-based system or subsystem that can perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

When the query 110 is received by the search engine 130, the search engine 130 identifies resources that satisfy the query 110. For example, the search engine 130 can perform a retrieval algorithm with respect to data elements stored in the first search index 160 and/or the second search index 162. Specifically, as an example, the search engine 130 can generally include an indexing engine 120 that indexes resources (e.g., data elements included in a dataset), the indices 160 and 162 that store the indexed information, and a ranking engine 152 or other software that generates scores for the resources that satisfy the query 110 and that ranks the resources according to their respective scores.

More particularly, the indices 160 and 162 can store one or more indexed representations for each of a number of data elements included in a dataset. In one example, the indexed representation(s) for each data element can correspond to embeddings that have been generated from at least a portion of the data elements. For example, an “embedding” can be a learned representation of a data element that is expressed (e.g., as a numerical vector) in a learned latent space. For example, the indexing engine 120 can include a machine-learned embedding generation model that can generate the embeddings for the data elements. An embedding can be generated for the data element as a whole or can be generated for a portion of the data element (e.g., one or more frames extracted from a larger video).

In other examples, the indexed representation(s) for each data element can correspond to other forms of encodings of the data elements. In other examples, the indexed representation(s) for each data element can correspond to the raw data elements themselves.

According to an aspect of the present disclosure, the indexing of a dataset (e.g., by the indexing engine 120 into the indices 160 and 162) can occur over a number of storage periods. During the pendency of each storage period, any new data elements that are added to the dataset can be indexed by the indexing engine 120 into the first data index 160, while the majority (e.g., all) of the existing data elements of dataset can be indexed in the second data index 162.

Then, upon expiration of the storage period, the new data elements included in the first data index 160 can be transferred from the first data index 160 stored by the first set of storage media to the second data index 162 stored by the second set of storage media. Additionally or alternatively, all of the data elements indexed in the second data index 162 can be updated (e.g., recomputed or otherwise re-indexed).

Thus, in some implementations, an information retrieval index can be split into two (e.g., partially overlapping) parts: fresh data stored in first data index 160 (e.g., including new data elements introduced within the most recent storage period (e.g., the last 30 days)) and stable data stored in second data index 162 (e.g., including all data elements existing in the dataset except those introduced within at least a portion of the most recent storage period (e.g., except elements introduced within the last 7 days).

Furthermore, the first data index 160 can be stored on storage media having relatively lower latency but higher operational cost (e.g., RAM), while the second data index 162 can be stored on storage media having relatively higher latency but lower operational cost (e.g., SSD). One benefit of such a split is that the search system 114 needs to support (complex) instant updates of only the small fresh first data index 160. The search system 114 (e.g., the indexing engine 120) can then update the larger stable second data index 162 periodically by recomputing a new version of the entire served dataset at once.

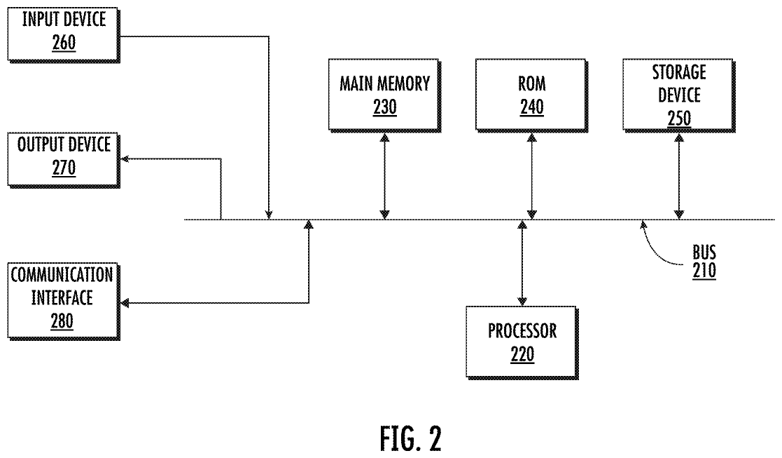

FIG. 2 is a diagram of an example client or server entity (hereinafter called “client/server entity”), which may correspond to one or more of clients 104 and/or search system 114, according to an implementation consistent with the principles of the invention. The client/server entity may include a bus 210, a processor 220, a main memory 230, a read only memory (ROM) 240, a storage device 250, an input device 260, an output device 270, and a communication interface 280. Bus 210 may include a path that permits communication among the elements of the client/server entity.

Processor 220 may include a conventional processor, microprocessor, or processing logic that interprets and executes instructions. Main memory 230 may include a random access memory (RAM) or another type of dynamic storage device that may store information and instructions for execution by processor 220. ROM 240 may include a conventional ROM device or another type of static storage device that may store static information and instructions for use by processor 220. Storage device 250 may include a magnetic and/or optical recording medium and its corresponding drive.

Input device 260 may include a conventional mechanism that permits an operator to input information to the client/server entity, such as a keyboard, a mouse, a pen, voice recognition and/or biometric mechanisms, etc. Output device 270 may include a conventional mechanism that outputs information to the operator, including a display, a printer, a speaker, etc. Communication interface 280 may include any transceiver-like mechanism that enables the client/server entity to communicate with other devices and/or systems. For example, communication interface 280 may include mechanisms for communicating with another device or system via one or more communications networks.

As will be described in detail below, the client/server entity, consistent with the principles of the invention, may perform certain searching-related operations. The client/server entity may perform these operations in response to processor 220 executing software instructions contained in a computer-readable medium, such as memory 230. A computer-readable medium may be defined as a physical or logical memory device and/or carrier wave.

The software instructions may be read into memory 230 from another computer-readable medium, such as data storage device 250, or from another device via communication interface 280. The software instructions contained in memory 230 may cause processor 220 to perform processes that will be described later. Alternatively, hardwired circuitry may be used in place of or in combination with software instructions to implement processes consistent with the principles of the invention. Thus, implementations consistent with the principles of the invention are not limited to any specific combination of hardware circuitry and software.

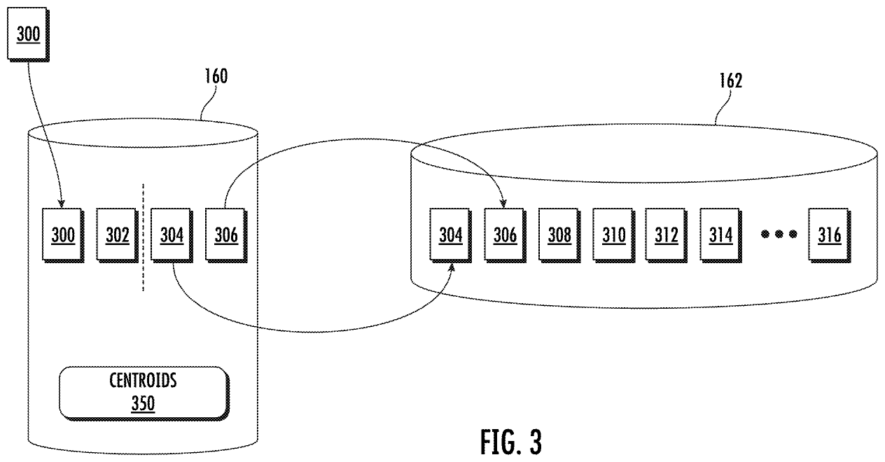

FIG. 3 depicts a graphical representation of a process for indexing data elements according to example embodiments of the present disclosure. In particular, as shown in FIG. 3, a computing system (e.g., the indexing engine 120 of FIG. 1) can maintain a first data index 160 stored in a first set of storage media and a second data index 162 stored in a second set of storage media. As examples, the first set of storage media can be or include Random Access Memory (RAM) storage media; and the second set of storage media can be or include solid State Drive (SSD) storage media.

In some implementations, the first data index 160 and second data index and 162 can be updated over a number of storage periods. As one example, a storage period can be one day, one week, one month, or other measures of time. In other examples, storage periods can be triggered by the accumulation of a threshold amount of data and/or other dynamic characteristics or attributes. In other examples, storage periods can be defined or dynamically managed based on various data retention requirements.

In some implementations, during pendency of a given storage period, any additional data elements that are added to the dataset can be indexed in the first data index 160. For example, as illustrated in FIG. 3, a representation 300 of a newly added data element is added to the first data index 160. As used herein, an additional or newly added data element refers to a data element that is being newly indexed into the index of the dataset; the data element may or may not have been in existence or generally included in the dataset prior to the indexing event; but is considered “additional” or “newly added” to the dataset when indexed for the first time. Thus, in some implementations, the first data index 160 can be referred to as a fresh data index.

The second data index 162 can include representations of data elements that have been indexed in previous storage periods. For example, as illustrated in FIG. 3, the second data index 162 can include data elements 308-316, which have been indexed in previous storage periods.

Referring still to FIG. 3, during pendency of the storage period or upon expiration of the storage period, the computing system (e.g., the indexing engine 120 of FIG. 1) can transfer some or all of the additional data elements contained in the first data index 160 stored by the first set of storage media to the second data index 162 stored by the second set of storage media.

As one example, in some implementations, during pendency of the storage period, any representation that has been stored in the first data index 160 for greater than a threshold amount of time (e.g., but less than the entirety of a storage period) can be transferred from the first data index 160 to the second data index 162. However, in some implementations, the transferred data representations may still be maintained in the first data index 160 until expiration of the storage period. As examples, a storage period may be 30 days while the threshold amount of time may be 7 days.

Thus, in some implementations, any representation that has been stored in the first data index 160 for 7 or more days may be transferred to the second data index 162, yet also maintained in the first data index 160 until expiration of the storage period (e.g., or some other trigger such as expiration of a second threshold amount of time that is greater than the first).

As examples, as illustrated in FIG. 3, representations 304 and 306 may have been stored in the first data index 160 for greater than the threshold amount of time and therefore may be transferred to the second data index 162 while still being maintained in the first data index 160. Thus, in some implementations, the first data index 160 and the second data index 162 may be partially overlapping. However, representations 300 and 302 may have been stored in the first data index 160 for less than the threshold amount of time. Therefore, representations 300 and 302 can be stored in the first data index 160 only.

In some implementations, upon the expiration of the storage period, the computing system (e.g., the indexing engine 120 of FIG. 1) can recompute some or all of the second data index 162. For example, following re-computation, the second data index 162 can also include any representations that were previously included in the first data index 160 (e.g., including representations 300-306). In some implementations, re-computation may include updating or determining a new representation for every data element.

Furthermore, according to another aspect, in some implementations, a plurality of centroids 350 can be stored in the first set of storage media alongside the first data index 160. The plurality of centroids 350 can respectively correspond to a plurality of partitions of the existing data elements included in the second data index 162 stored by the second set of storage media. For example, the centroids 350 can be used to perform a hierarchical retrieval technique (e.g., such as a hierarchical nearest neighbor search).

For example, first, the hierarchical retrieval technique can include identifying one or more of the centroids 350 stored by the first set of storage media based on the query. Next, the hierarchical retrieval technique can include accessing, from the second set of storage media, only the data elements included in the one or more of the partitions respectively associated with the one or more of the centroids 350 identified based on the query.

Hierarchical retrieval techniques of this nature can identify results that are responsive to the query with reduced computational costs (e.g., by evaluating only a smaller subset of the indexed data elements included in the identified partition(s), rather than all indexed data elements). Further, because the centroids 350 are maintained in the first set of storage media having the lower latency, they can be accessed and/or updated faster and with reduced computational cost. In some implementations, during a storage period or upon the expiration of a storage period, the centroids 350 can be re-computed (e.g., using k-means partitioning). For example, the centroids 350 can be re-computed to account for the newly added representations 300-306.

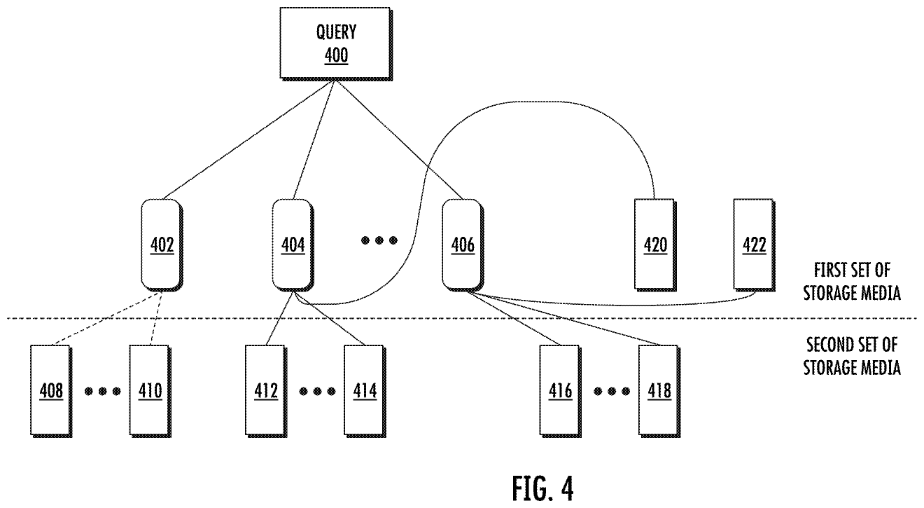

As one example, FIG. 4 depicts a graphical diagram of an example hierarchical retrieval technique according to example embodiments of the present disclosure. Items illustrated above the horizontal dashed line in FIG. 4 are stored in the first set of storage media (e.g., RAM); while items illustrated below the horizontal dashed line are stored in the second set of storage media (e.g., SSD).

Specifically, in the simplified example of FIG. 4, a number of centroids have been defined. For example, three centroids 402, 404, and 406 are shown. A number of representations of data elements are associated with each centroid. For example, representations 408-410 are associated with centroid 402; representations 412-414 and 420 are associated with centroid 402; and representations 416-418 and 422 are associated with centroid 406. The representations may be stored in different data indices. For example, representations 408-418 may be existing representations stored in a second data index stored by the second set of storage media; while representations 420 and 422 may be newly added representations that are stored in a first data index stored by the first set of storage media. The number of centroids and representations is greatly simplified for the purposes of illustration.

When a query 400 is received, it is first compared with some or all of the centroids. For example, comparison may include computation of a distance or difference in vector space (e.g., a cosine similarity). Some subset of the “closest” (e.g., smallest distance or difference) or most similar centroids may be identified. For example, centroids 404 and 406 may be identified. Then, only the representations associated with the identified centroids may be evaluated. For example, representations 412-422 may be evaluated (but representations 408-410 may not be evaluated). Some number of the closest representations may be identified (e.g., representations 412, 414, and 416 may be identified as responsive to the query 400).

Although only a two-layer hierarchy is shown, larger or more complex hierarchies can be used instead. For example, additional layer(s) of centroids can be generated which further partition the centroids in the layer(s) below. These additional layer(s) can be similarly stored in the first set of storage media.

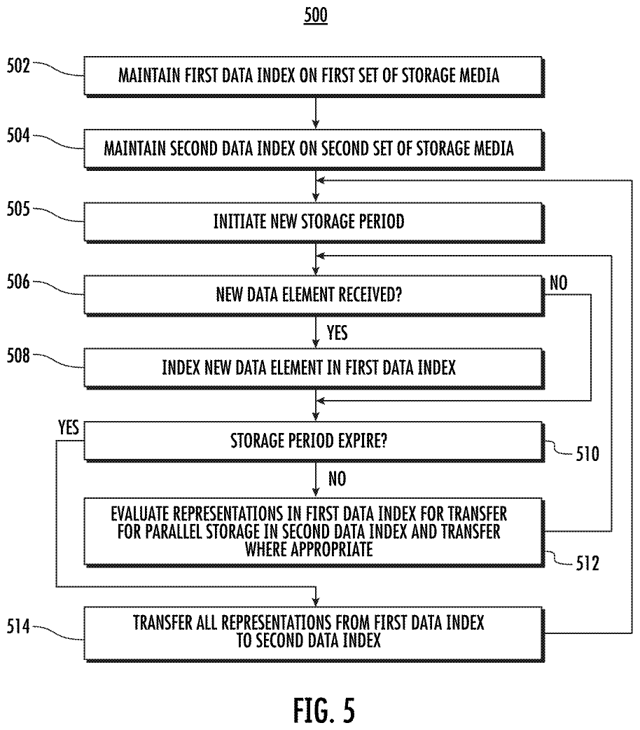

FIG. 5 depicts a flow chart diagram of an example method to index data elements according to example embodiments of the present disclosure.

At 502, a computing system (e.g., the indexing engine 120 of FIG. 1) can maintain a first data index on a first set of storage media.

At 504, the computing system (e.g., the indexing engine 120 of FIG. 1) can maintain a second data index on a second set of storage media.

At 505, the computing system (e.g., the indexing engine 120 of FIG. 1) can initiate a new storage period.

At 506, the computing system (e.g., the indexing engine 120 of FIG. 1) can determine whether a new data element has been received or added to the dataset. If yes, method 500 can proceed to 508. If no, method 500 can proceed to 510.

At 508, the computing system (e.g., the indexing engine 120 of FIG. 1) can index the new data element in the first data index.

At 510, the computing system (e.g., the indexing engine 120 of FIG. 1) can determine whether the current storage period has expired. If no, method 500 can proceed to 512.

At 512, the computing system (e.g., the indexing engine 120 of FIG. 1) can evaluate representations included in the first data index for transfer for parallel storage in the second data index and can perform the transfer(s) where appropriate. For example, any representation(s) that have been stored in the first data index for greater than a threshold period of time (e.g., which may be less than a storage period) can be transferred for storage in the second data index, but may, in some implementations, also remain in the first data index. After 512, method 500 can return to 506.

Referring again to 510, if it is determined at 510 that the current storage period has expired, then method 500 can proceed to 514.

At 514, the computing system (e.g., the indexing engine 120 of FIG. 1) can transfer all representations from the first data index to the second data index. In some implementations, step 514 can include deleting the representations from the first data index. In some implementations, step 514 can include recomputing some or all of the second data index so as to include the representations previously included in the first data index.

After 514, method 500 can return to 505 and initiate a new storage period.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method for maintaining a dynamically updating datastore, the method comprising:
storing, using a first set of storage media, a first data index that indexes elements of a dataset introduced within a storage period, the first set of storage media having a first latency associated therewith;
storing, using a second set of storage media, a second data index at least partially overlapping the first data index, the second data index indexing elements of the dataset except those introduced within a portion of the storage period, the portion less than the storage period, the second set of storage media having a second latency associated therewith, the second latency being greater than the first latency; and
periodically recomputing new versions of the second data index to include one or more representations of elements indexed in the first data index, the one or more representations of elements maintained in the first data index and the second data index for an overlapping time period.

2. The computer-implemented method of claim 1, wherein the elements of the dataset comprise at least one embedding representation expressed as a numerical vector.

3. The computer-implemented method of claim 2, wherein the embedding representation is generated by encoding at least one element of the dataset.

4. The computer-implemented method of claim 1, wherein periodically recomputing new versions of the second data index comprises computing a new version of an entirety of the second data index.

5. The computer-implemented method of claim 1, wherein periodically recomputing new versions of the second data index comprises determining at least one updated representation to replace at least one element stored in the second data index.

6. The computer-implemented method of claim 1, wherein periodically recomputing new versions of the second data index is triggered by accumulation of a threshold amount of data.

7. The computer-implemented method of claim 1, wherein periodically recomputing new versions of the second data index is triggered by expiration of a measure of time.

8. The computer-implemented method of claim 1, wherein periodically recomputing new versions of the second data index further comprises transferring indices of a plurality of elements stored in the first data index for greater than a threshold amount of time to the second data index.

9. The computer-implemented method of claim 1, further comprising storing a plurality of centroids defining one or more partitions.

10. The computer-implemented method of claim 9, wherein periodically recomputing new versions of the second data index further comprises recomputing the plurality of centroids.

11. The computer-implemented method of claim 9, further comprising:
identifying one or more of the plurality of centroids stored by the first set of storage media based on a query;
accessing, from the second set of storage media, only data elements included in the one or more partitions respectively associated with the one or more of the plurality of centroids identified based on the query.

12. The computer-implemented method of claim 11, wherein identifying the one or more of the plurality of centroids based on the query comprises a comparison of the query and the one or more of the plurality of centroids in vector space.

13. The computer-implemented method of claim 1, further comprising identifying one or more results responsive to a query based on a retrieval algorithm defined relative to both the first data index and the second data index.

14. The computer-implemented method of claim 1, wherein:
the first set of storage media comprise Random Access Memory (RAM) storage media; and
the second set of storage media comprise Solid State Drive (SSD) storage media.

15. A computing system, comprising:
a first set of storage media that stores a first data index that indexes elements of a dataset introduced within a storage period, the first set of storage media having a first latency associated therewith; and
a second set of storage media that stores a second data index at least partially overlapping the first data index, the second data index indexing elements of the dataset except those introduced within a portion of the storage period, the portion less than the storage period, the second set of storage media having a second latency associated therewith, the second latency being greater than the first latency.

16. The computing system of claim 15, wherein the elements of the dataset comprise at least one embedding representation expressed as a numerical vector.

17. The computing system of claim 16, wherein the embedding representation is generated by encoding at least one element of the dataset.

18. The computing system of claim 15, wherein the computing system further comprises a plurality of centroids defining one or more partitions.

19. The computing system of claim 15, wherein the computing system identifies one or more results responsive to a query based on a retrieval algorithm defined relative to both the first data index and the second data index.

20. A computing system, comprising:
one or more processors; and
one or more non-transitory computer-readable media that store instructions that, when executed by the one or more processors, cause the computing system to perform operations, the operations comprising:
periodically recomputing new versions of a second data index to include one or more representations of elements indexed in a first data index, the one or more representations of elements maintained in the first data index and the second data index for an overlapping time period.
